(19) United States
(12) Patent Application Publication
(10) Pub. No.: US 2010/0194870 A1
(43) Pub. Date: Aug. 5, 2010

(54) ULTRA-COMPACT APERTURE CONTROLLED DEPTH FROM DEFOCUS RANGE SENSOR

(76) Inventors: Ovidiu Ghita, Dublin (IE); Paul Francis Whelan, Dublin (IE)

Correspondence Address: SEED INTELLECTUAL PROPERTY LAW GROUP PLLC, 701 FIFTH AVE, SUITE 5400, SEATTLE, WA, 98104, US

(21) Appl. No.: 12/696,990

(22) Filed: Jan. 29, 2010

Related U.S. Application Data
(63) Continuation of application No. PCT/EP2008/060144, filed on Aug. 1, 2008.
(60) Provisional application No. 60/953,339, filed on Aug. 1, 2007.

(51) Int. Cl. H04N 5/232; H04N 7/18

(52) U.S. Cl. 348/65; 348/348; 348/E05.045; 348/E07.085

(57) ABSTRACT

The present application teaches an implementation of an ultra-compact range sensor based on aperture varying passive depth from defocus. An embodiment of the present application teaches a range sensor, which is a fast LCD matrix that allows the acquisition of a plurality of images with variable focal levels by changing the size of the aperture of a typical lens. The range sensor of the present application may be implemented in mobile devices or used in the construction of medical endoscopes able to perform depth recovery.

### CROSS REFERENCE TO RELATED APPLICATION

This is a continuation application of PCT/EP2008/060144 filed on Aug. 1, 2008, now pending, which claims the benefit under 35 U.S.C. §119(e) of U.S. Provisional Patent Application Ser. No. 60/953,339, filed Aug. 1, 2007, each of which are incorporated herein by reference in their entirety.

### BACKGROUND

1. Technical Field

The present application is directed to range sensors which determine the range using depth from defocus (DFD) techniques in which an estimate of the depth is obtained by evaluating the level of defocus (blur) in two or more images captured with different focal settings.

2. Description of the Related Art

Depth information plays an important role for many computer vision-based applications since it allows 3D scene interpretation. The 3D information may be obtained using a large number of passive and active range sensing strategies. One known technique employs two cameras spaced a distance apart to acquire stereo image information from which depth may be estimated. Another technique is depth from defocus (DFD), which is a relatively new depth estimation method that has evolved in both passive and active forms. Depth from defocus works on the principle that during the image formation process, objects are imaged according to their position in space. Thus objects situated close to the position where the image is in focus are accurately imaged, while others, not placed close to this position are blurred. The level of blurring provides an indication of the distance between the imaged object and the surface of best focus. Thus, the degree of blurring can provide an indication of the distance of an object from the surface of best focus. More particularly, the presentation of an object point P being imaged on the sensor of a camera is shown in FIG. 1. In this diagram, P is the point being imaged, f is the focal length of the lens, u is the distance of the point P from the lens (i.e., the object distance) and s is the distance from the lens to the plane I_{f} where the point P would be in focus in accordance with the Gauss law for a thin lens:

$$\frac{1}{f} = \frac{1}{u} + \frac{1}{s}$$

However, in the scenario presented if the object point P is shifted to position P₁ or P₂ that is located farther away from the lens with the result that instead of being focused at a point (d=0, for the point P), the image of the displaced point P₁ (i=1, 2) is distributed over an area d₁ (i=1, 2) on the sensor (i.e., it is blurred). The degree of blurring is dependent on the aperture of the lens D and may be stated as:

$${d}_{i} = Ds ( \frac{1}{f} - \frac{1}{{u}_{i}} - \frac{1}{s} ) , i = 1 , 2 , … n$$

As the values of D, f, and s are generally known, if the diameter of the blur d₁ may be measured then the object distance uᵢ may be calculated. It will be appreciated that the spatial shift from the surface of best focus can be either positive or negative (i.e., depending on whether the object is in front or behind the best focus surface). Accordingly, to estimate the blur level (range) uniquely, at least two images are captured with different focal settings.

The conventional approach to acquire the two images with different focal levels, as shown in FIG. 2, employs a half mirror 30 to split the light arriving from a scene 40 into two separate beams and present them to two separate cameras 10, 20. The first camera 10 is one with a relatively small aperture (pinhole) which results in an image in which all points are relatively sharply focused and the second camera 20 which receives light via a second mirror 50 employs a large aperture in which points away from the plane of best focus are blurred in accordance with their distance from the plane of best focus. Mathematical techniques have been developed to measure the degree of blurring which would be familiar to those skilled in the art. These techniques compare the spatial frequency content of the pinhole focused image with those of the larger aperture to estimate the degree of blurring. While blurring has the effect of a low pass filter, the degree of blurring may be estimated by the degree to which high frequency content has been suppressed. However, it will be appreciated that if the objects being imaged are plain surfaces with no texture there may be no high frequency content and accordingly it will be impossible to estimate the level of suppression of the high frequency information in the large aperture image with respect to the high frequency information content of the pinhole image. In such scenarios though, it is known to impress a light pattern onto the bland surface to provide artificial texture.

Examples of prior art in the general field include A. Pentland, “A new sense for depth of field”, IEEE Transactions on Pattern Analysis and Machine Intelligence, vol. 9, no. 4, pp. 523-531, 1987, M. Subbarao, “Parallel depth recovery by changing camera parameters”, Proc. of the International Conference on Computer Vision (ICCV 88), pp. 149-155, 1988 and M. Subbarao and G. Surya, “Depth from Defocus: A Spatial Domain Approach,” International Journal of Computer Vision, vol. 13, no. 3, pp. 271-294, 1994.

The conventional approach described above is employed in expensive and typically large set-ups for example machine vision automation and inspection systems, which are highly accurate. The space demands for the mirror arrangements and two cameras are such that the systems are entirely unsuitable for environments where space is at a premium.

The present application seeks to provide a smaller, less expensive arrangement.

### BRIEF SUMMARY

The present application provides a simple range sensor which employs the principle of depth estimation from defocus, in which the depth\range of an object is determined from the difference in the degree of blurring of the object between two (or more) images taken with different apertures.

The resulting system is simpler than the two-camera arrangements previously employed in that only a single camera is required. The system is compact and thus may be employed in circumstances not previously possible or practicable, for example within very small devices.

Accordingly, a first embodiment provides a range sensor for determining the range of an object. The range sensor has an image sensing device for acquiring images of the object, which may be a CMOS or a CCD sensor array. A lens is employed conventionally to present a representation of the scene to the image sensing element. An electrically actuateable aperture is provided which is associated with the lens and varies the amount of light presented from the lens to the image sensing element. The electrically actuateable aperture has a first aperture setting and a second aperture setting. The range sensor system is configured to acquire a first image of the scene at the first aperture setting and a second image of the scene at the second aperture setting and to determine the range of the object by comparing the degree of blurring of the object between the first and second images.

Suitably, the electrically actuateable aperture is an LCD device having at least one switchable crystal element, the crystal element having an opaque state and a transparent state. The range sensor system may be configured to automatically adjust a parameter of the image sensing device to ensure the light exposure of the first and second images is the same. The parameter may be the sensitivity of the image sensing device, shutter speed and\or the white balance of the image sensing device.

In one particular configuration, the range sensor employs an LCD device as the electrically actuateable aperture and the imaging sensing device is a CCD or CMOS sensing device and the sensor is configured to capture a plurality of images with differing focal levels from which the range information may be calculated.

A further embodiment provides a portable electronic device comprising a range sensor of this type. The portable electronic device may be a mobile telephone.

The range sensor may also be employed in an inspection system. This is particularly advantageous where the inspection system is small in size which would prevent the use of prior art systems such as surgical inspection systems, including for example endoscopes.

A further embodiment provides a method of determining the range of an object in a scene acquired as a digital image by a sensing device at a first aperture setting of the sensing device, wherein the aperture is electrically actuateable the method comprising the step of changing the aperture setting of the sensing device to a second aperture setting and acquiring a second digital image of the scene at this second aperture setting and comparing the frequency content of at least part of the imaged object in the digital images to determine the degree of high frequency suppression between the images and estimating the range from the determined degree of high frequency suppression.

Other features, advantages and embodiments will become apparent from the detailed description that follows.

### DESCRIPTION OF THE SEVERAL VIEWS OF THE DRAWINGS

The present application will now be described with reference to the following drawings in which:

FIG. 1 is a ray diagram representation that explains the operation of depth from defocus techniques generally,

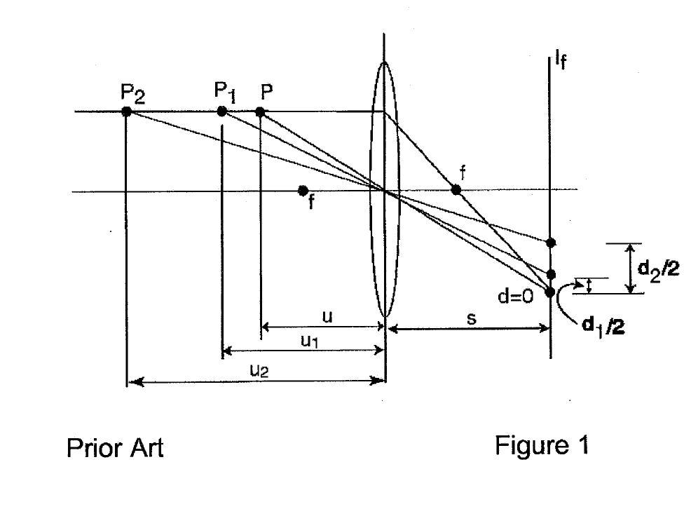

FIG. 2 is a representation of a prior art two-camera arrangement used with depth from defocus techniques,

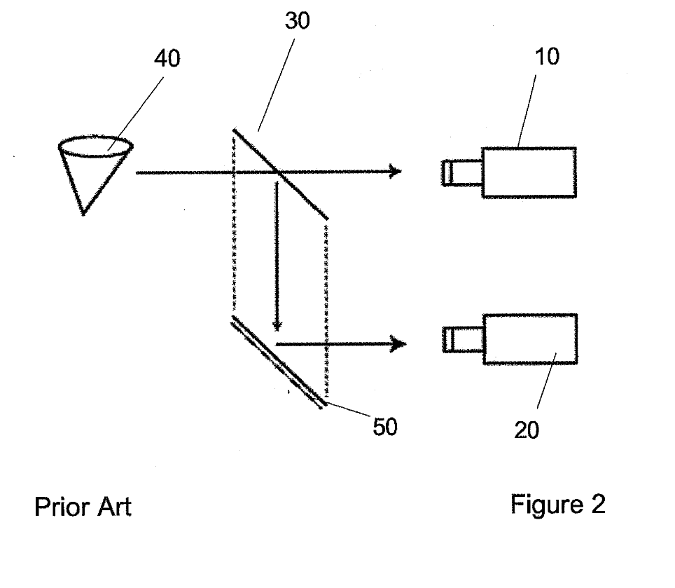

FIG. 3 is a representation of the proposed ultra-compact depth from defocus range sensor,

FIG. 4 is a representation of the LCD device that is applied to emulate a variable aperture.

### DETAILED DESCRIPTION

The present application was initially directed to mobile phones. Mobile phones are entirely unsuitable devices for incorporating prior art stereo range systems or depth from defocus systems, since they generally have only one image sensing device. Adding an extra image sensing device would be difficult because of space constraints. Moreover, in stereo systems precise camera calibration would be required which would be hampered by the fact that mobile devices are generally subjected to mechanical shocks during normal operation. Thus, the development of a system that is able to maintain the camera calibration for a pair of CCD\CMOS elements would be costly. In addition, due to factors such as dust, the level of illumination between these cameras would be uneven.

The present application provides a solution for the implementation of a range sensor within a mobile device, in which a single camera is employed in conjunction with a variable aperture. Incorporating a variable aperture into such a system is not however straightforward, as the aperture operation must be reasonably fast in order to capture the defocused images with minimal motion artifacts, i.e., to ensure the same image is captured twice by the camera and not displaced by movement of the user's hand. Moreover, it must be compact to fit within the tight landscape of the mobile phone. In addition, minimal modifications to existing mobile phone camera elements would be advantageous as it would increase the acceptance of manufacturers to incorporate the technology. The resulting design described below is therefore easily adaptable to most mobile phone configurations and only requires minimal changes. Moreover, the algorithm required to extract the depth information is simple and may be easily implemented in hardware and/or software in contrast to the previously discussed stereo techniques. Whilst, the range system is suitable for mobile phones it is also suitable for other systems where space is a consideration.

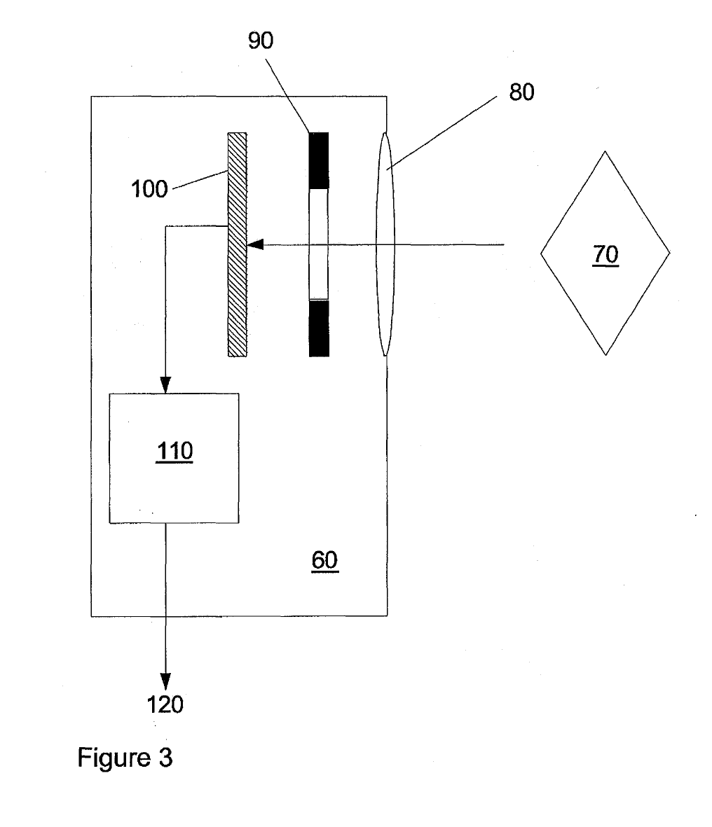

The range system 60, as shown in the exemplary implementation of FIG. 3, comprises an image sensing device 100 for acquiring images through a lens 80 of a scene containing one or more objects 70 for which the range is to be determined. The image sensing device 100 is suitably a charge coupled device (CCD) or a complementary metal oxide semiconductor (CMOS) imaging device of the type conventionally employed as the camera in mobile phones and other consumer electronic devices.

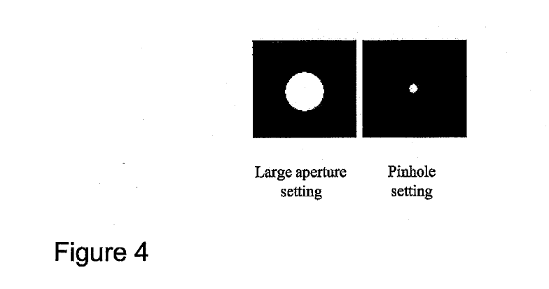

As described above, the compact implementation raises some technical problems and thus whilst a motorized or magnetically operable aperture for the lens may be employed, the solution may be bulky and might suffer from mechanical constraints such as inertia and the relatively large response time required to control the position of the diaphragm. To circumvent these problems, the present application employs an electrically actuateble\operable\switchable aperture 90. Whilst this aperture is without moving parts it nonetheless mimics the operation of a mechanical aperture. However, the aperture is operated by an electrical signal alone and there is no mechanical motion. In one arrangement, the aperture comprises an LCD device, suitably a matrix LCD device (as illustrated in FIG. 4). In this arrangement, the individual matrix elements of the LCD device are switchable from an opaque state in which light is unable to pass through to a substantially transparent state when light is able to pass through. The state of the individual elements is switchable by means of application of a suitable electrical signal. Thus, for acquiring an image with a large aperture, the elements of the matrix may be switched so that all of the elements are transparent and the maximum amount of light is allowed to pass through the LCD device to the sensor. When a small aperture is required, the elements of the LCD device may be switched so that only the element(s) of the central portion of the LCD device are transparent and the surrounding elements are opaque. The aperture device may have a plurality of elements or it may simply have one. In the case of the single element configuration, a central portion of the device is always transparent with the surrounding portion being switchable between an opaque and a transparent state to effect a switching between apertures.

An advantage of employing a LCD matrix is that it is fully programmable and thus may be employed with different CCD\CMOS sensing elements depending on their sensitivity. Similarly, it offers the advantage that a larger than pinhole aperture may be employed where there is insufficient light for a pinhole.

It will be appreciated that since the quantum of light hitting the sensor will be significantly less when the aperture is small a compensation procedure would be required to ensure that the exposure between the image acquired with the small aperture is consistent with that acquired using the large aperture.

Also, the sensor should be able to perform automatic white level correction to compensate for the reduced level of light when the aperture is used with the pinhole settings. Most sensors fitted on mobile devices have day/night settings options, thus are able to improve the sensor sensitivity when the level of light arriving at the CCD\CMOS element is reduced. To obtain best results, the sensitivity to light of the CCD\CMOS element should be high in order to minimize the size of the transparent area when the image is captured with the pinhole settings.

Since the passive DFD sensor uses the optical signal associated with two differently focused images to determine the depth, the present application may minimize, as much as possible, the errors caused by the aberrations introduced by the lens. The optical distortions caused by the optics fitted on mobile devices may be severe. In this regard, the present application may perform a camera calibration to minimize the projective errors using a one-step calibration procedure.

As each of the two images are acquired, the image information is passed to a processor 110 which in turn may store the information in memory. Once both images have been acquired the depth may be calculated from the captured image data by the processor and the depthVange information 120 is output. The method of calculation may be, but is not limited to, techniques based on either high pass filtering or narrow-band filters. As discussed above, these methods are only suitable for determining the range of objects with texture. The present method may evaluate the texture strength in the defocused images by using oriented high pass filters.

It is important to note that the modifications required to implement the range sensor detailed in this patent application do not affect in any way the normal operation of the camera of the mobile phone (in normal operation the lens aperture will be set to the default (open) value). Moreover, the implementation of the range sensor requires only limited amount of hardware resources to compute the depth information and perform image registration between the defocused images.

Range information is important for many applications that may be developed for mobile devices. For example, a potential application is the segmentation of the foreground object in an input image in order to select the region of interest where the object is located within the image. In this fashion, the user may elect to store only the information associated with the foreground object if the background does not present interesting details.

Typically, the most interesting features in an image, e.g., faces or objects placed in the foreground, are typically in focus and the image detail is high. If the mobile device is able to identify the location of these features, an adaptive method to compress the image based on the focus level may be devised. In this regard, the features in focus may be compressed with minimal loss of information whether the parts of the image that describe the background may be compressed more aggressively based on user defined settings. Thus, the range information can play a vital role in obtaining an optimal compression rate for a JPEG image and as a result more images may be stored by the device and the time required (and the cost) to send this information is drastically reduced.

Another possible application for the range sensor detailed in the present application is its potential use in the construction of medical inspection devices such as endoscopes that are able to extract 3D information. The endoscopes used in current clinical examinations typically return only 2D information and the medical practitioner may adjust the focal setting to obtain images with maximum clarity. Depth information may aid the medical practitioner in the interpretation of 2D data more efficiently. The standard endoscope may be easily modified using the methodology detailed in this patent application to also extract the depth information along with the standard 2D information that is normally analyzed by the medical practitioner. This extra information may provide another source of data that the medical practitioner may evaluate and interpret and draw conclusions about the medical condition of the patient.

1. A range sensor for determining the range of an object in a scene,
an image sensing device for acquiring images of the scene;
a lens for presenting a representation of the scene upon the image sensing element;
an electrically actuateable aperture associated with the lens for varying the amount of light presented from the lens to the image sensing element, the electrically actuateable aperture having a first aperture setting and a second aperture setting, wherein the range sensor system is configured to acquire a first image of the scene at the first aperture setting and a second image of the scene at the second aperture setting and to determine the range of the object by comparing the degree of blurring of the object between the first and second images.

2. A range sensor according to claim 1, wherein the electrically actuateable aperture is a liquid crystal display (LCD) device.

3. A range sensor according to claim 2, wherein the LCD device comprises at least one switchable crystal elements, the crystal element having an opaque state and a transparent state.

4. A range sensor according to claim 1, wherein the sensor system is configured to automatically adjust a parameter of the image sensing device to ensure the light exposure of the first and second images is the same.

5. A range sensor according to claim 4, wherein the parameter is the sensitivity of the image sensing device.

6. A range sensor according to claim 4, wherein the parameter is the white balance of the image sensing device.

7. A range sensor according to claim 4, wherein the parameter is the speed of the image sensing device.

8. A range sensor according to claim 1 wherein a liquid crystal display (LCD) device is used as the electrically actuateable aperture and the imaging sensing device is a charged coupled device (CCD) or complementary metal oxide semiconductor (CMOS) sensing device, and the sensor is configured to capture a plurality of images with differing focal levels from which the range information may be calculated.

9. A portable electronic device comprising a range sensor according to claim 1.

10. A portable electronic device according to claim 9, wherein the portable electronic device is a mobile telephone.

11. An inspection system comprising the range sensor of claim 1.

12. A surgical inspection system comprising the range sensor of claim 1.

13. A surgical inspection system according to claim 12, wherein the inspection system is an endoscope.

14. A method of determining the range of an object in a scene acquired as a digital image by a sensing device at a first aperture setting of the sensing device, wherein the aperture is electrically actuateable the method comprising the step of changing the aperture setting of the sensing device to a second aperture setting and acquiring a second digital image of the scene at this second aperture setting and comparing the frequency content of at least part of the imaged object between the digital images to determine the degree of high frequency suppression between the images and estimating the range of the object from the determined degree of high frequency suppression.

15. A surgical inspection system for studying an object within a patient, the surgical inspection system comprising:
an image sensing device for acquiring images from a scene containing the object within the patient;
a lens for presenting a representation of the scene upon the image sensing element;
a liquid crystal display (LCD) device functioning as an electrically actuateable aperture for the lens for varying the amount of light presented from the lens to the image sensing element, the LCD device having a first aperture setting and a second aperture setting, wherein the range sensor system is configured to acquire a first image of the scene at the first aperture setting and a second image of the scene at the second aperture setting and to determine the range of the object by comparing the degree of blurring of the object between the first and second images, wherein the system is configured to automatically adjust a parameter of the image sensing device to ensure the light exposure of the first and second images is the same.

16. A surgical inspection system according to claim 15, wherein the LCD device comprises at least one switchable crystal elements, the crystal element having an opaque state and a transparent state and where the change between these states is caused by switching between the first aperture setting and second aperture setting.

17. A system according to claim 15, wherein the parameter is the sensitivity of the image sensing device.

18. A system according to claim 15, wherein the parameter is the white balance of the image sensing device.

19. A system according to claim 15, wherein the parameter is the speed of the image sensing device.
